(19) United States
(12) Patent Application Publication
(10) Pub. No.: US 2012/0299316 A1
(43) Pub. Date: Nov. 29, 2012

(54) LATCH MECHANISM FOR RELEASABLY SECURING COVERS OF PORTABLE DEVICES USED IN RUGGED ENVIRONMENTS

(76) Inventor: Alan Mangaroo, Oakville (CA)

(21) Appl. No.: 13/196,303

(22) Filed: Aug. 2, 2011

Related U.S. Application Data
(60) Provisional application No. 61/489,793, filed on May 25, 2011.

(51) Int. Cl. E05C 1/08

(52) U.S. Cl. 292/179

(57) ABSTRACT

A latch mechanism for releasably securing a cover to a housing of a portable device. The latch mechanism includes a plurality of resilient members for retaining the latch mechanism in a locked configuration. The latch mechanism comprising a latch enclosure of the housing for positioning adjacent to the cover and having a plurality of interior surfaces and a latch body positioned in the latch enclosure and configured for reciprocal movement within the latch enclosure between a closed position and an open position. The latch mechanism uses a first resilient member of the plurality of resilient members positioned between the latch body and a first surface of the plurality of interior surfaces for biasing the latch body in a first direction between the open position and the closed position. The latch mechanism also uses a second resilient member of the plurality of resilient members for biasing at least a portion of the latch body in a second direction towards a second surface of the plurality of interior surfaces, such that the first direction and the second direction are laterally relative to one another. The second resilient member biases engagement of a first lock portion with a second lock portion.

(This application claims the benefit of U.S. Provisional Application No. 61.489,793 Filed May 25, 2011 in its entirety herein incorporated by reference.)

### FIELD

This invention relates to latching mechanisms for releasably securing covers to housings.

### BACKGROUND

In today's increasing mobile workforce, businesses and government organizations rely upon rugged computing devices such as personal data assistants (PDAs), sometimes known as enterprise digital assistants (EDAs), for mobile data applications. EDAs are portable handheld devices, typically battery powered, or tethered, and often have extra features for data capture, such as barcode readers, radio-frequency identification (RFID) readers, magnetic stripe card readers, or smart card readers, as well as wireless WAN/LAN/PAN voice and data communications capabilities. It is important for operational continuity of these businesses and organizations for their portable devices to be able withstand all-day everyday use in harsh or hazardous environments.

It is a fact that if a person is able to carry an object, they will inevitably drop it. The durability of the portable device is exceptionally critical since the information in the device is often more valuable than the device itself. Laptops, cell phones, PDA's, global positioning systems, cameras, calculators, and other portable devices have many delicate internally housed components that are essential to information storage and operational continuity. As such, portable devices are subjected to ruggedness standards, as rugged device construction can minimize the risk of damage and reduce the total cost of device ownership.

The ruggedized housing of the portable device typically has one or more covers that are releasably secured to a main housing by a manually operated latch, so as to provide for replacement of batteries, for servicing of internally housed components, as well as to connect peripheral devices to the main housing. Unfortunately, operation of the latches can be triggered prematurely when the portable device is subjected to a sudden impact, such as when dropped by the user, thereby releasing undesirably the latched cover. One consequence of premature operation of the latch is that housed components can become exposed to damage or otherwise dislodged from the housing interior. In the case of a battery, dislodgement affects operation of other components due to sudden interruption of their power supply when the electrical connection of the battery is dislodged.

### SUMMARY

It is an object of the present invention to provide an latching mechanism to obviate or mitigate at least some of the above-presented disadvantages.

It is a fact that if a person is able to carry an object, they will inevitably drop it. The durability of the portable device is exceptionally critical since the information in the device is often more valuable than the device itself. Laptops, cell phones, PDA's, global positioning systems, cameras, calculators, and other portable devices have many delicate internally housed components that are essential to information storage and operational continuity. As such, portable devices are subjected to ruggedness standards, as rugged device construction can minimize the risk of damage and reduce the total cost of device ownership. Contrary to current latch mechanisms, provided is a latch mechanism for releasably securing a cover to a housing of a portable device. The latch mechanism includes a plurality of resilient members for retaining the latch mechanism in a locked configuration. The latch mechanism comprising a latch enclosure of the housing for positioning adjacent to the cover and having a plurality of interior surfaces and a latch body positioned in the latch enclosure and configured for reciprocal movement within the latch enclosure between a closed position and an open position. The latch mechanism uses a first resilient member of the plurality of resilient members positioned between the latch body and a first surface of the plurality of interior surfaces for biasing the latch body in a first direction between the open position and the closed position. The latch mechanism also uses a second resilient member of the plurality of resilient members for biasing at least a portion of the latch body in a second direction towards a second surface of the plurality of interior surfaces, such that the first direction and the second direction are laterally relative to one another. A latch locking mechanism is used for placing the latch mechanism in the locked configuration when the latch body is placed in the closed position, such that the latch locking mechanism includes a first lock portion on the latch body and a corresponding second lock portion on the housing, such that the second resilient member biases engagement of the first lock portion with the second lock portion. The latch mechanism can also have a cover retaining mechanism for retaining the cover on the housing when the latch body being positioned in the closed position, the cover retaining mechanism including a first retain portion on the latch body configured for engaging with a corresponding second retain portion on the cover, the first resilient member biasing engagement of the first retain portion with the second retain portion when the cover being positioned on the housing.

A first aspect provided is a latch mechanism for releasably securing a cover to a housing of a portable device, the latch mechanism including a plurality of resilient members for retaining the latch mechanism in a locked configuration, the latch mechanism comprising: a latch enclosure of the housing for positioning adjacent to the cover and having a plurality of interior surfaces; a latch body positioned in the latch enclosure and configured for reciprocal movement within the latch enclosure between a closed position and an open position; a first resilient member of the plurality of resilient members positioned between the latch body and a first surface of the plurality of interior surfaces, the first resilient member for biasing the latch body in a first direction between the open position and the closed position; a second resilient member of the plurality of resilient members for biasing at least a portion of the latch body in a second direction towards a second surface of the plurality of interior surfaces, the first direction and the second direction being laterally relative to one another; a latch locking mechanism for placing the latch mechanism in the locked configuration when the latch body being placed in the closed position, the latch locking mechanism including a first lock portion on the latch body and a corresponding second lock portion on the housing, the second resilient member biasing engagement of the first lock portion with the second lock portion; and a cover retaining mechanism for retaining the cover on the housing when the latch body being positioned in the closed position, the cover retaining mechanism including a first retain portion on the latch body configured for engaging with a corresponding second retain portion on the cover, the first resilient member biasing engagement of the first retain portion with the second retain portion when the cover being positioned on the housing.

A second aspect provided is a latch mechanism for releasably securing a cover to a housing of a portable device, the latch mechanism including a plurality of resilient members for retaining the latch mechanism in a locked configuration, the latch mechanism comprising: a latch enclosure of the cover for positioning adjacent to the housing and having a plurality of interior surfaces; a latch body positioned in the latch enclosure and configured for reciprocal movement within the latch enclosure between a closed position and an open position; a first resilient member of the plurality of resilient members positioned between the latch body and a first surface of the plurality of interior surfaces, the first resilient member for biasing the latch body in a first direction between the open position and the closed position; a second resilient member of the plurality of resilient members for biasing at least a portion of the latch body in a second direction towards a second surface of the plurality of interior surfaces, the first direction and the second direction being laterally relative to one another; a latch locking mechanism for placing the latch mechanism in the locked configuration when the latch body being placed in the closed position, the latch locking mechanism including a first lock portion on the latch body and a corresponding second lock portion on the cover, the second resilient member biasing engagement of the first lock portion with the second lock portion; and a cover retaining mechanism for retaining the cover on the housing when the latch body being positioned in the closed position, the cover retaining mechanism including a first retain portion on the latch body configured for engaging with a corresponding second retain portion on the housing, the first resilient member biasing engagement of the first retain portion with the second retain portion when the cover being positioned on the housing.

A further aspect is a latch mechanism configured as a self contained unit for mounting to a compatible cover of a portable device for use in releasably securing the cover to a housing employing a plurality of resilient members for retaining the latch mechanism in a locked configuration, the latch mechanism comprising: a latch enclosure suitable for mounting in the cover for positioning adjacent to the housing and having a plurality of interior surfaces; a latch body positioned in the latch enclosure configured for reciprocal movement within the latch enclosure between a closed position and an open position; a first resilient member of the plurality of resilient members positioned between the latch body and a first surface of the plurality of interior surfaces, the first resilient member biasing the latch body in first direction between the open position and the closed position; a second resilient member of the plurality of resilient members biasing at least a portion of the latch body in a second direction, such that the first direction and the second direction are laterally relative to one another; and a latch locking mechanism for placing the latch mechanism in the locked configuration when the latch body is placed in the closed position, the latch locking mechanism including a first lock portion on the latch body configured for engaging with a corresponding second lock portion located on the cover, the second resilient member biasing engagement of the first lock portion with the second lock portion.

### BRIEF DESCRIPTION OF THE DRAWINGS

Exemplary embodiments of the invention will now be described in conjunction with the following drawings, by way of example only, in which:

FIG. 1 is a planar view of a portable device with a latch mechanism;

FIG. 2 is a view of cross section A-A of the portable device of FIG. 1;

FIG. 3 is a view of cross section B-B of the portable device of FIG. 1 showing the latch mechanism in a locked state in a closed position;

FIG. 4 is a planar view showing operation of the latch mechanism of FIG. 1 in an open position in relation to a cover of the portable device;

FIG. 5 is a planar view showing operation of the latch mechanism of FIG. 1 in the closed position in relation to a cover of the portable device;

FIG. 6 is a view of cross section B-B of the portable device of FIG. 1 showing the latch mechanism in an unlocked state in the closed position;

FIG. 7 is a view of cross section B-B of the portable device of FIG. 1 showing the latch mechanism in the open position;

FIG. 8 shows an alternative embodiment of the latch mechanism in cross section A-A of the portable device of FIG. 1;

FIG. 9 shows a further alternative embodiment of the latch mechanism in cross section A-A of the portable device of FIG. 1;

FIG. 10 shows cross sectional view of a further alternative embodiment of the latch mechanism of the portable device of FIG. 1;

FIG. 11 shows an alternative embodiment of the latch mechanism of FIG. 2 as a self contained unit; and

### DESCRIPTION

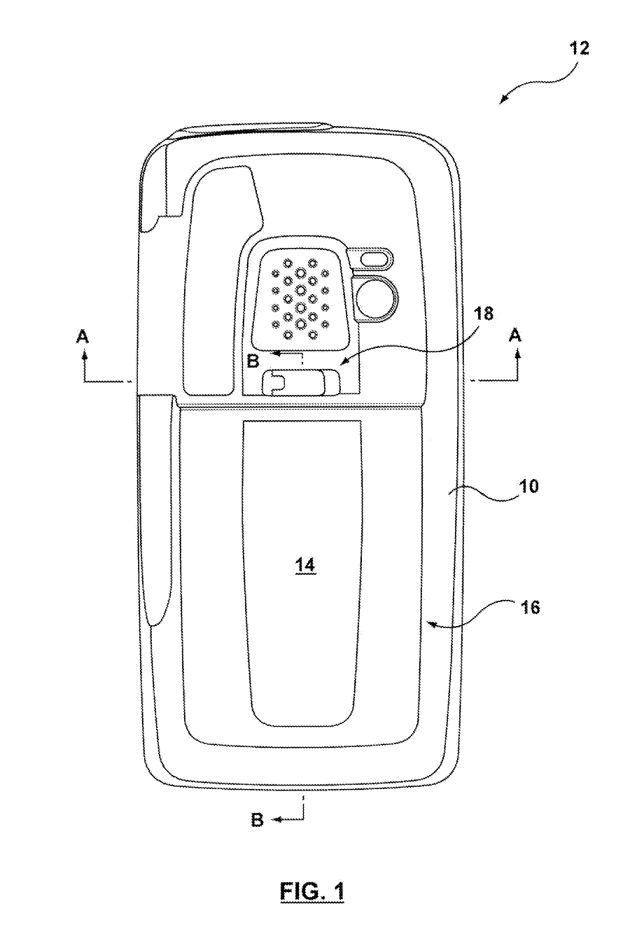

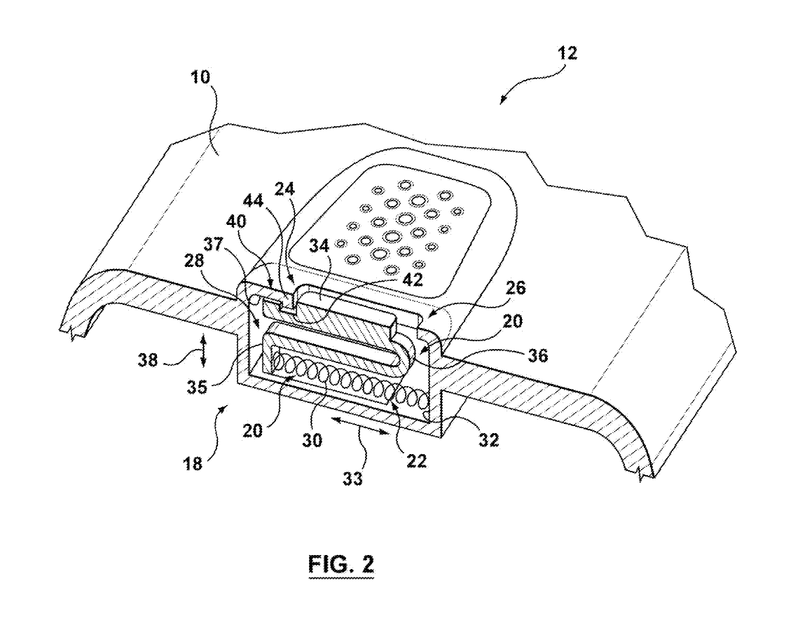

Referring to FIG. 1, shown is a housing 10 of a portable device 12 having a cover 14 that is releasably secured to a compartment 16 of housing 10 by a latch mechanism 18. One example of compartment 16 is a battery compartment, which is configured to retain a battery (not shown) when covered by cover 14. As further described below, latch mechanism 18 is biased towards a locked position by a plurality of resilient members 20 (see FIG. 2), whereas operation of latch mechanism 18 against the biases of resilient members 20 provides for removal of cover 14 from compartment 16. It is recognized that resilient members 20 can be springs, arms, or other elastic objects used to store mechanical energy during operation of latch mechanism 18. Examples of resilient members 20 can be tension springs, compression springs, or torsion springs. Resilient members 20 can be shaped as a coil, flat bar, U-shaped bar or otherwise bent material. The material used to form resilient members 20 can be plastic, metal, or any other suitable material providing the desired combination of rigidity and elasticity for the bias of latch mechanism 18.

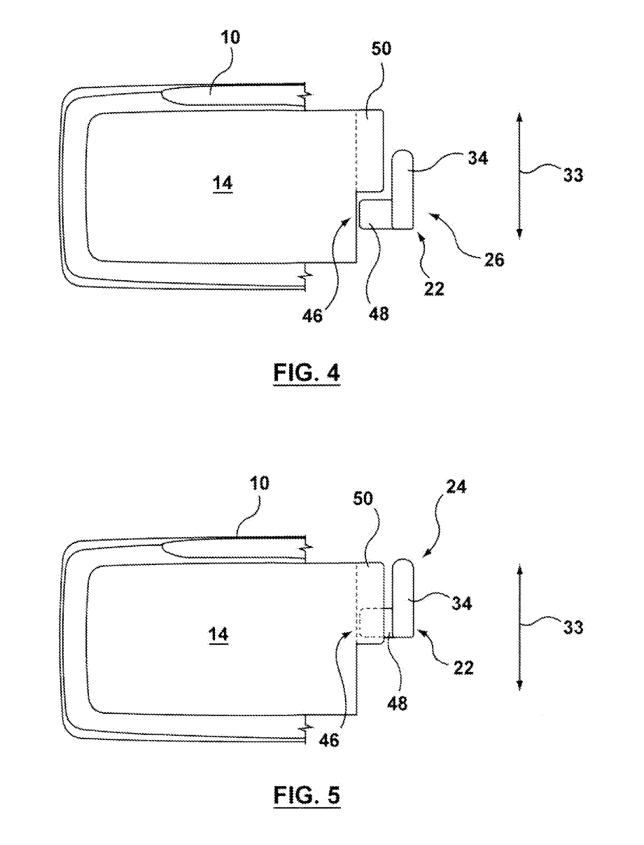

Referring to FIG. 2, shown is a side view of latch mechanism 18. It is recognized that cover 14 is not shown for illustration purposes only. Latch mechanism 18 includes a latch body 22 configured to slide, move or otherwise reciprocate between a closed position 24 (see FIG. 5) and an open position 26 (see FIG. 4) within a latch enclosure 28 of the housing 10, as biased by a first resilient member 30 of the plurality of resilient members 20. First resilient member 30 is positioned between a first interior surface 32 of latch enclosure 28 and latch body 22, so as to bias latch body 22 from open position 26 towards closed position 24 along direction 33. It is also recognized that alternatively, first resilient member 30 can bias latch body 22 from closed position 24 towards open position 26 along direction 33, as desired. Latch enclosure 28 is configured to retain latch body 22 therein while at the same time providing for movement of latch body 22 between closed position 24 and open position 26.

Referring again to FIG. 2, latch body 22 can also have a button 34 coupled to a body portion 35 of latch body 22 by a second resilient member 36 of the plurality of resilient members 20, such that second resilient member 36 biases button 34 outwardly from body portion 35 in direction 38 towards a second interior surface 37 of latch enclosure 28. It is recognized that direction 33 and direction 38 are laterally relative to one another. In this example embodiment, second resilient member 36 is a section of curved bar material (e.g. U-shaped) joining button 34 to body portion 35, such that by example button 34, body portion 35 and second resilient member 36 form an integral component of latch mechanism 18.

Latch body 22 and latch enclosure 28 are also have a latch locking mechanism 40 for retaining latch body 22 in closed position 24 (i.e. placing latch mechanism 18 in a locked configuration) when a first lock portion 42 (of latch locking mechanism 40) on latch body 22 is engaged with a second lock portion 44 (of latch locking mechanism 40) on second interior surface 37 of latch enclosure 28. Second resilient member 36 biases first lock portion 42 and second lock portion 44 towards one another. As shown in FIG. 2, latch mechanism 18 is in the locked configuration as latch body 22 is in closed position 24 and first lock portion 42 and second lock portion 44 of latch locking mechanism 40 are engaged with one another.

Referring to FIG. 2, shown is an example embodiment of latch locking mechanism 40, such that first lock portion 42 is a notch in button 34 sized to receive second lock portion 44 as a lip positioned on second interior surface 37, when latch body 22 is positioned in closed position 24. It is also recognized that first lock portion 42 can be the lip and second lock portion 44 can be the notch, as desired. It is also recognized that second lock portion 44 can be part of latch enclosure 28 or can be part of housing 10.

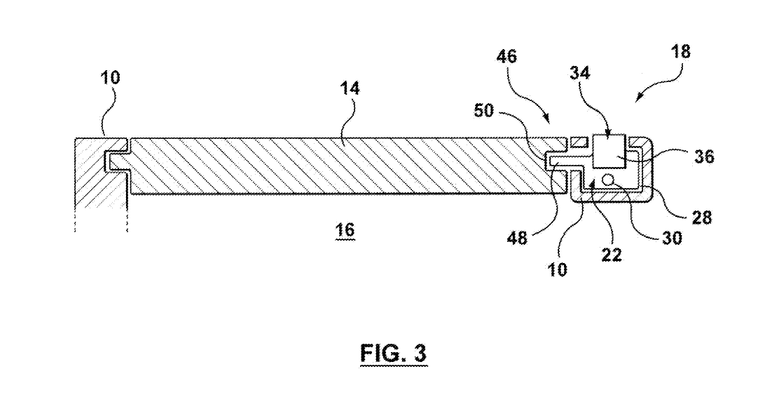

Referring to FIG. 3, shown is a side view of latch body 22 in cooperation with cover 14 to provide a cover retaining mechanism 46 having a first retain portion 48 on latch body 22 engaged with a second retain portion 50 on cover 14. Shown is an example embodiment of cover retaining mechanism 46, such that first retain portion 48 is a projection in latch body 22 sized to be received in second retain portion 50 configured as a groove positioned on cover 14, when latch body 22 is positioned in closed position 24 (see FIG. 2). It is also recognized that first retain portion 48 can be the groove and second retain portion 50 can be the projection, as desired. It is also recognized that there can be multiple first retain portions 48 and corresponding second retain portions 50 (e.g. a series of adjacent projections and corresponding grooves), as desired. As shown in FIG. 4, where only cover 14 and latch body 22 are shown for illustration purposes, positioning of latch body 22 in open position 26 provides for disengagement of first retain portion 48 with second retain portion 50, thus facilitating removal of cover 14 from housing 10. As shown in FIG. 5, positioning of latch body 22 in closed position 24 provides for engagement of first retain portion 48 with second retain portion 50, e.g. projection received in groove, thus facilitating retention of cover 14 on housing 10.

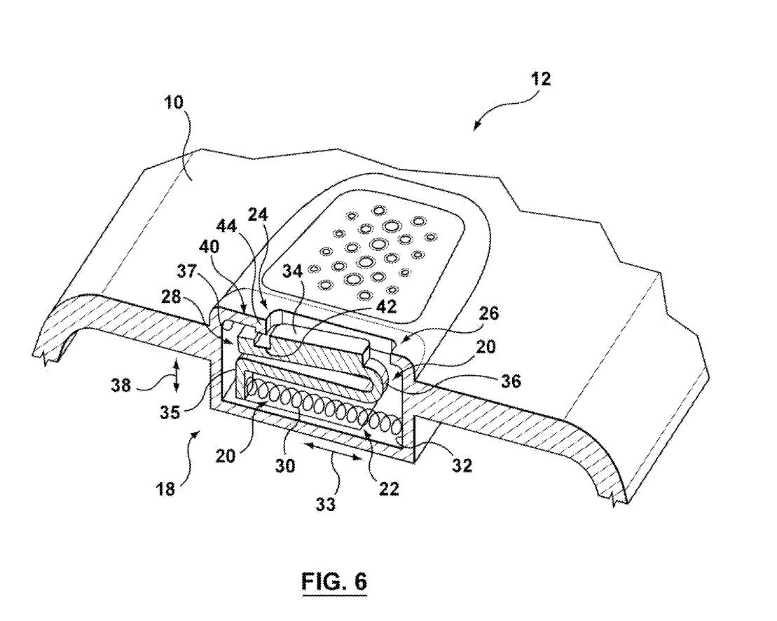

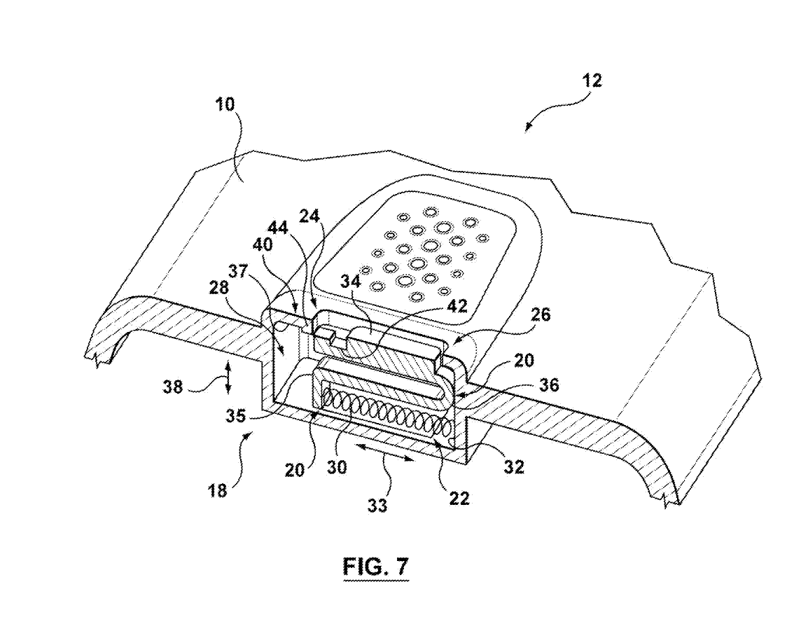

Referring to FIGS. 2, 6 and 7, shown is operation of latch mechanism 18 from closed position 24 (providing retention of cover 14 on housing 10) to open position 26 (facilitating removal of cover 14 from housing 10). Referring to FIG. 6, shown is opening of latch locking mechanism 40, such that first lock portion 42 and second lock portion 44 are disengaged from one another by forcing button 34 against the bias of second resilient member 36, i.e. pushing button 34 in direction 38 towards body portion 35. Once latch locking mechanism 40 is unlocked, latch body 22 can be moved towards open position 26, as shown in FIG. 7 by moving latch body 22 in direction 33 towards first surface 32, thus providing for disengagement of first retain portion 48 with second retain portion 50 and subsequent ability of device 12 user to remove cover 14 from housing 10 (see FIG. 4).

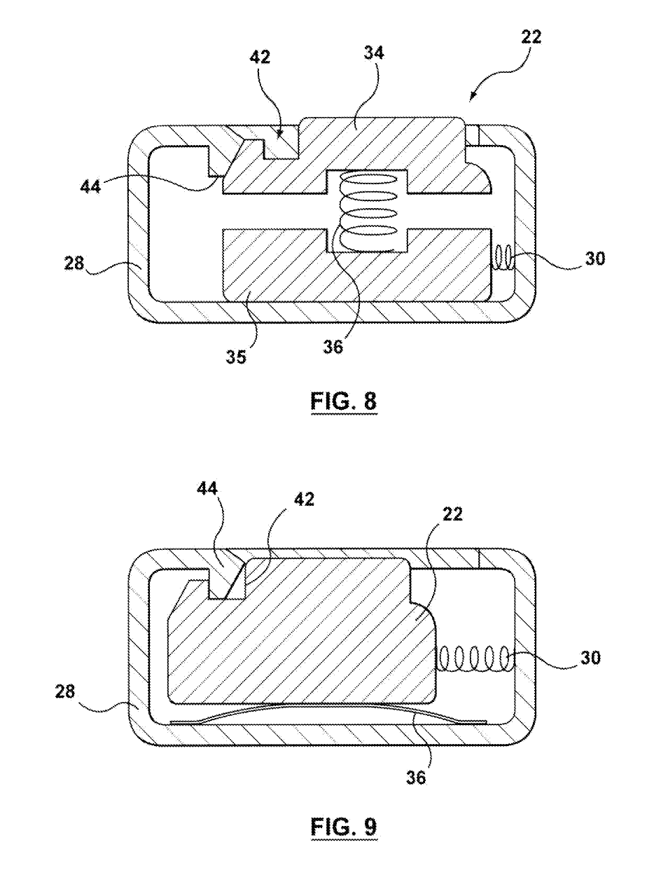

Referring to FIG. 8, shown is an alternative embodiment of latch mechanism 18, such that second resilient member 36 is a spring positioned between individual components button 34 and body portion 35 of the latch body 22. Referring to FIG. 9, shown is a further alternative embodiment of latch mechanism 18, such that second resilient member 36 is positioned between latch body 22 and at least one surface of the plurality of interior surfaces of latch enclosure 28. In this manner, it is latch body 22 itself that is biased by second resilient member 36 to facilitate engagement of first lock portion 42 and second lock portion 44.

Accordingly, in view of the above, latch mechanism 18 is for releasably securing cover 14 to housing 10 of portable device 12, such that latch mechanism 18 includes the plurality of resilient members 20 for retaining latch mechanism 18 in the locked configuration. Latch mechanism 18 has latch enclosure 28 of housing 10 for positioning adjacent to cover 14 and has the plurality of interior surfaces. Latch body 22 is positioned in latch enclosure 28 and configured for reciprocal movement within latch enclosure 28 between closed position 24 and open position 26. First resilient member 30 of the plurality of resilient members 20 is positioned between latch body 22 and first surface 32 of the plurality of interior surfaces, such that first resilient member 30 biases latch body 22 in first direction 33 between open position 26 and closed position 24. Second resilient member 36 of the plurality of resilient members 20 biases at least a portion of latch body 22 (e.g. button 34 or whole latch body 22) in second direction 38 towards second surface 37 of the plurality of interior surfaces, first direction 33 and second direction 38 being laterally relative to one another. Latch locking mechanism 40 is used to place latch mechanism 18 in the locked configuration when latch body 22 is placed in closed position 24, such that latch locking mechanism 18 includes first lock portion 42 on latch body 22 and corresponding second lock portion 44 on housing 10, second resilient member 36 biasing engagement of first lock portion 42 with second lock portion 44. Cover retaining mechanism 46 is used to retain cover 14 on housing 10 when latch body 22 is positioned in closed position 24. Cover retaining mechanism includes first retain portion 48 on latch body 22 configured for engaging with corresponding second retain portion 50 on cover 14. First resilient member 30 biases engagement of first retain portion 48 with second retain portion 50 when cover 14 is positioned on housing 10.

Referring to FIG. 9, shown is a further embodiment of latch mechanism 18 such that latch enclosure 28 is part of cover 14, where first retain portion 48 is positioned on latch body 22 of cover 14 and second retain portion 50 is positioned on housing 10. In this manner, latch mechanism 18 can be included as part of cover 14. Accordingly, in view of the further embodiment of FIG. 9, latch mechanism 18 is for releasably securing cover 14 to housing 10 of portable device 12, such that latch mechanism 18 includes the plurality of resilient members 20 for retaining latch mechanism 18 in the locked configuration. Latch mechanism 18 has latch enclosure 28 of cover 14 for positioning adjacent to housing 10 and has the plurality of interior surfaces. Latch body 22 is positioned in latch enclosure 28 and configured for reciprocal movement within latch enclosure 28 between closed position 24 and open position 26. First resilient member 30 of the plurality of resilient members 20 is positioned between latch body 22 and first surface 32 of the plurality of interior surfaces, such that first resilient member 30 biases latch body 22 in first direction 33 between open position 26 and closed position 24. Second resilient member 36 of the plurality of resilient members 20 biases at least a portion of latch body 22 (e.g. button 34 or whole latch body 22) in second direction 38 towards second surface 37 of the plurality of interior surfaces, first direction 33 and second direction 38 being laterally relative to one another. Latch locking mechanism 40 is used to place latch mechanism 18 in the locked configuration when latch body 22 is placed in closed position 24, such that latch locking mechanism 18 includes first lock portion 42 on latch body 22 and corresponding second lock portion 44 on cover 14, second resilient member 36 biasing engagement of first lock portion 42 with second lock portion 44. Cover retaining mechanism 46 is used to retain cover 14 on housing 10 when latch body 22 is positioned in closed position 24. Cover retaining mechanism includes first retain portion 48 on latch body 22 configured for engaging with corresponding second retain portion 50 on housing 10. First resilient member 30 biases engagement of first retain portion 48 with second retain portion 50 when cover 14 is positioned on housing 10.

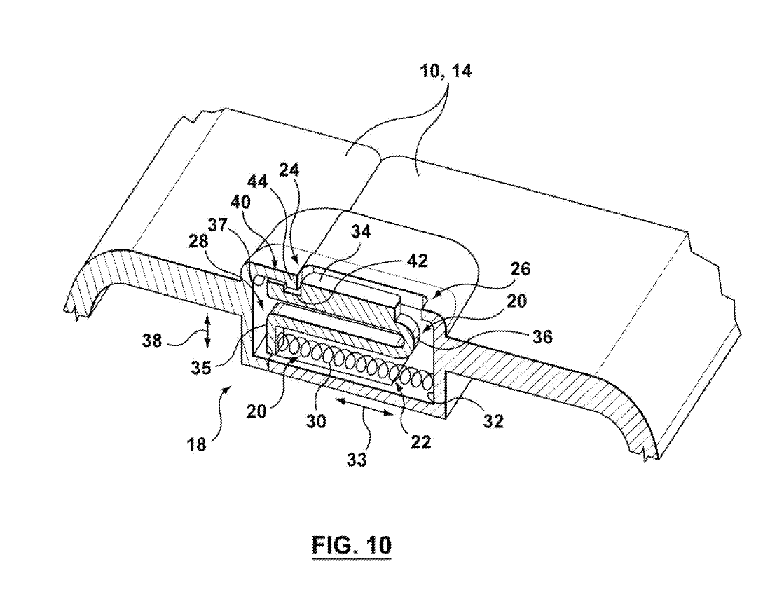

Referring to FIG. 10, shown is a further embodiment of latch mechanism 18 such that coupling of cover 14 with adjacent housing 10 is facilitated by latch locking mechanism 40. Latch mechanism 18 releasably secures cover 14 to housing 10 of portable device 12 using the plurality of resilient members 20 for retaining latch mechanism 18 in the locked configuration. Latch mechanism 18 comprises latch enclosure 28 positioned in either housing 10 or cover 14 (or both housing 10 and cover 14 in the case where latch enclosure 28 is shared between cover 14 and housing 10) for positioning adjacent to cover 14 (or housing 10) and has a plurality of interior surfaces. Latch body 22 is positioned in latch enclosure 28 and is configured for reciprocal movement within latch enclosure 28 between closed position 24 and open position 26. First resilient member 30 of the plurality of resilient members 20 is positioned between latch body 22 and first surface 32 of the plurality of interior surfaces. First resilient member 30 biases latch body 22 in first direction 33 between open position 24 and closed position 26. Second resilient member 36 of the plurality of resilient members 20 biases at least a portion of latch body 22 in second direction 38, such that first direction 33 and second direction 38 are laterally relative to one another. It is noted in this embodiment that direction 33 is between cover 14 and housing 10, rather than along cover 14 or housing 10 as shown in FIG. 2. Latch locking mechanism 40 places latch mechanism 18 in the locked configuration when latch body 22 is placed in closed position 24. Latch locking mechanism 40 includes first lock portion 42 on latch body 22 and corresponding second lock portion 44 on either housing 10 or cover 14 depending on whether latch enclosure 28 is in cover 14 or housing 10 respectively. Second resilient member 36 biases engagement of first lock portion 42 with second lock portion 44. In one version of this embodiment, latch locking mechanism 40 can also facilitate the retention of cover 14 on housing 10. Optionally, latch mechanism 18 can also include a separate cover retaining mechanism (not shown) for facilitating increased retention of cover 14 on housing 10 when latch body 22 is positioned in closed position 26, such that cover retaining mechanism can include one or more first retain portions on the latch body configured for engaging with corresponding one or more second retain portions situated on cover 14 (in the case where latch enclosure 28 is in housing 10) or on housing 10 (in the case where latch enclosure 28 is in cover 14). When used, it is recognized that first resilient member 30 (and/or second resilient member 36) can be used to bias engagement of first retain portion(s) with second retain portion(s) when cover 14 is positioned on housing 10.

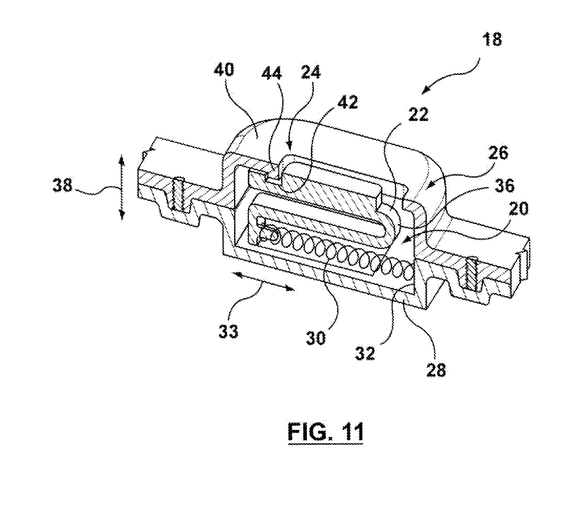

Referring to FIG. 11, shown is a further embodiment of latch mechanism 18 as a self contained unit that can be coupled to a compatible housing or cover (not shown). In this manner, either the second retain portion and/or the second lock portion (not shown) can be positioned on the corresponding cover or housing, as appropriate. In the manner of this embodiment, latch mechanism 18 as a self contained unit is configured for being mounted in either the cover and/or the housing for use in releasably securing the cover to the housing of the portable device using the plurality of resilient members 20 for retaining latch mechanism 18 in the locked configuration. Latch mechanism 18 comprises latch enclosure 28 suitable for mounting in either the housing (and/or the cover) for positioning adjacent to the cover (or the housing) and has a plurality of interior surfaces. Latch body 22 is positioned in latch enclosure 28 and is configured for reciprocal movement within latch enclosure 28 between closed position 24 and open position 26. First resilient member 30 of the plurality of resilient members 20 is positioned between latch body 22 and first surface 32 of the plurality of interior surfaces. First resilient member 30 biases latch body 22 in first direction 33 between open position 24 and closed position 26. Second resilient member 36 of the plurality of resilient members 20 biases at least a portion of latch body 22 in second direction 38, such that first direction 33 and second direction 38 are laterally relative to one another. Latch locking mechanism 40 places latch mechanism 18 in the locked configuration when latch body 22 is placed in closed position 24. Latch locking mechanism 40 includes first lock portion 42 on latch body 22 configured for engaging with corresponding second lock portion 44 (not shown) located on either the housing or the cover depending on whether latch enclosure 28 is in the cover or the housing respectively. Second resilient member 36 biases engagement of first lock portion 42 with second lock portion 44. In one version of this embodiment, latch locking mechanism 40 can also facilitate the retention of the cover on the housing. Optionally, latch mechanism 18 can also include a separate cover retaining mechanism (not shown) for facilitating retention of the cover on the housing when latch body 22 is positioned in closed position 26, such that cover retaining mechanism can include one or more first retain portions on latch body 22 configured for engaging with corresponding one or more second retain portions situated on the cover (in the case where latch enclosure 28 is in the housing) or on the housing (in the case where latch enclosure 28 is in the cover). When used, it is recognized that first resilient member 30 (and/or second resilient member 36) can be used to bias engagement of first retain portion(s) with second retain portion(s) when the cover is positioned on the housing.

Referring again to FIG. 11, it is recognized that the latch mechanism 18 can have a plurality of second resilient members 36, e.g. two second resilient members 36 that cooperate to bias engagement of first lock portion 42 with second lock portion 44. Further, it is recognised that the first resilient member 30 can be comprised of two or more resilient members 20, as desired, which cooperate to bias latch body 22 in first direction 33 between open position 24 and closed position 26.

We claim:

1. A latch mechanism for releasably securing a cover to a housing of a portable device, the latch mechanism including a plurality of resilient members for retaining the latch mechanism in a locked configuration, the latch mechanism comprising:
a latch enclosure of the housing for positioning adjacent to the cover and having a plurality of interior surfaces;
a latch body positioned in the latch enclosure and configured for reciprocal movement within the latch enclosure between a closed position and an open position;
a first resilient member of the plurality of resilient members positioned between the latch body and a first surface of the plurality of interior surfaces, the first resilient member for biasing the latch body in a first direction between the open position and the closed position;
a second resilient member of the plurality of resilient members for biasing at least a portion of the latch body in a second direction towards a second surface of the plurality of interior surfaces, the first direction and the second direction being laterally relative to one another;
a latch locking mechanism for placing the latch mechanism in the locked configuration when the latch body being placed in the closed position, the latch locking mechanism including a first lock portion on the latch body and a corresponding second lock portion on the housing, the second resilient member biasing engagement of the first lock portion with the second lock portion; and
a cover retaining mechanism for retaining the cover on the housing when the latch body being positioned in the closed position, the cover retaining mechanism including a first retain portion on the latch body configured for engaging with a corresponding second retain portion on the cover, the first resilient member biasing engagement of the first retain portion with the second retain portion when the cover being positioned on the housing.

2. The latch mechanism of claim 1 further comprising the latch body having a body portion and a button such that the second resilient member is positioned between the button and body portion for biasing the button outwardly from the body portion in the second direction.

3. The latch mechanism of claim 2, wherein the second lock portion is on the second surface of the latch enclosure.

4. The latch mechanism of claim 1, wherein the second resilient member is positioned between one surface of the plurality of interior surfaces and the latch body.

5. The latch mechanism of claim 4, wherein the one surface is a third surface opposite the second surface.

6. The latch mechanism of claim 1, wherein the cover is a battery compartment cover.

7. The latch mechanism of claim 1, wherein the first lock portion is a notch.

8. The latch mechanism of claim 1, wherein the first retain portion is a projection.

9. The latch mechanism of claim 8, wherein the first retain portion and the second retain portion are of a plurality of retain portions.

10. The latch mechanism of claim 1, wherein at least one of the resilient members is a spring.

11. A latch mechanism for releasably securing a cover to a housing of a portable device, the latch mechanism including a plurality of resilient members for retaining the latch mechanism in a locked configuration, the latch mechanism comprising:
a latch enclosure of the cover for positioning adjacent to the housing and having a plurality of interior surfaces;
a latch body positioned in the latch enclosure and configured for reciprocal movement within the latch enclosure between a closed position and an open position;
a first resilient member of the plurality of resilient members positioned between the latch body and a first surface of the plurality of interior surfaces, the first resilient member for biasing the latch body in a first direction between the open position and the closed position;
a second resilient member of the plurality of resilient members for biasing at least a portion of the latch body in a second direction towards a second surface of the plurality of interior surfaces, the first direction and the second direction being laterally relative to one another;
a latch locking mechanism for placing the latch mechanism in the locked configuration when the latch body being placed in the closed position, the latch locking mechanism including a first lock portion on the latch body and a corresponding second lock portion on the cover, the second resilient member biasing engagement of the first lock portion with the second lock portion; and
a cover retaining mechanism for retaining the cover on the housing when the latch body being positioned in the closed position, the cover retaining mechanism including a first retain portion on the latch body configured for engaging with a corresponding second retain portion on the housing, the first resilient member biasing engagement of the first retain portion with the second retain portion when the cover being positioned on the housing.

12. The latch mechanism of claim 11 further comprising the latch body having a body portion and a button such that the second resilient member is positioned between the button and body portion for biasing the button outwardly from the body portion in the second direction.

13. The latch mechanism of claim 12, wherein the second lock portion is on the second surface of the latch enclosure.

14. The latch mechanism of claim 11, wherein the second resilient member is positioned between one surface of the plurality of interior surfaces and the latch body.

15. The latch mechanism of claim 14, wherein the one surface is a third surface opposite the second surface.

16. The latch mechanism of claim 11, wherein the cover is a battery compartment cover.

17. The latch mechanism of claim 11, wherein the first lock portion is a notch.

18. The latch mechanism of claim 11, wherein the first retain portion is a projection.

19. The latch mechanism of claim 18, wherein the first retain portion and the second retain portion are of a plurality of retain portions.

20. The latch mechanism of claim 11, wherein at least one of the resilient members is a spring.

21. A latch mechanism configured as a self contained unit configured for mounting to a compatible housing of a portable device for use in releasably securing a cover to the housing employing a plurality of resilient members for retaining the latch mechanism in a locked configuration, the latch mechanism comprising:
a latch enclosure suitable for mounting in the housing for positioning adjacent to the cover and having a plurality of interior surfaces;
a latch body positioned in the latch enclosure configured for reciprocal movement within the latch enclosure between a closed position and an open position;
a first resilient member of the plurality of resilient members positioned between the latch body and a first surface of the plurality of interior surfaces, the first resilient member biasing the latch body in first direction between the open position and the closed position
a second resilient member of the plurality of resilient members for biasing at least a portion of the latch body in a second direction, such that the first direction and the second direction are laterally relative to one another; and
a latch locking mechanism for placing the latch mechanism in the locked configuration when the latch body is placed in the closed position, the latch locking mechanism including a first lock portion on the latch body configured for engaging with a corresponding second lock portion coupled to the housing, the second resilient member biasing engagement of the first lock portion with the second lock portion.

22. A latch mechanism configured as a self contained unit for mounting to a compatible cover of a portable device for use in releasably securing the cover to a housing employing a plurality of resilient members for retaining the latch mechanism in a locked configuration, the latch mechanism comprising:
a latch enclosure suitable for mounting in the cover for positioning adjacent to the housing and having a plurality of interior surfaces;
a latch body positioned in the latch enclosure configured for reciprocal movement within the latch enclosure between a closed position and an open position;
a first resilient member of the plurality of resilient members positioned between the latch body and a first surface of the plurality of interior surfaces, the first resilient member biasing the latch body in first direction between the open position and the closed position
a second resilient member of the plurality of resilient members biasing at least a portion of the latch body in a second direction, such that the first direction and the second direction are laterally relative to one another; and
a latch locking mechanism for placing the latch mechanism in the locked configuration when the latch body is placed in the closed position, the latch locking mechanism including a first lock portion on the latch body configured for engaging with a corresponding second lock portion located on the cover, the second resilient member biasing engagement of the first lock portion with the second lock portion.
